(19) United States
(12) Patent Application Publication
(10) Pub. No.: US 2016/0070106 A1
(43) Pub. Date: Mar. 10, 2016

(54) HEAD MOUNTED DISPLAY, DIGITAL DEVICE, AND CONTROL METHOD THEREOF

(71) Applicants: INTELLECTUAL DISCOVERY CO., LTD., Seoul (KR); SOCIALNETWORK CO., LTD, Seoul (KR)

(72) Inventor: Soowang PARK, Seoul (KR)

(73) Assignees: SOCIALNETWORK CO., LTD, Seoul (KR); INTELLECTUAL DISCOVERY CO., LTD., Seoul (KR)

(21) Appl. No.: 14/888,218

(22) PCT Filed: Jun. 5, 2013
(86) PCT No.: PCT/KR2013/004989

§ 371 Date: Oct. 30, 2015

(30) Foreign Application Priority Data
Apr. 30, 2013 (KR) 10-2013-0048914

(51) Int. Cl. G02B 27/01; G06F 3/01

(52) U.S. Cl. CPC G02B 27/0172; G06F 3/011

(57) ABSTRACT

The present invention relates to a head mounted display (HMD), a digital device, and a control method thereof for providing a display environment to be shared by a plurality of users. To this end, the present invention provides a head mounted display including: a processor for controlling the operation of the IIMD; a communication unit for transmitting/receiving data according to a command of the processor; and an optical shutter part for adjusting a light transmission according to a command of the processor, characterized in that the processor connects to the digital device to obtain the time-division display information of the digital device containing the display time information of a first display content and a second display content of the digital device which are alternately displayed, so as to open or close the optical shutter part according to the time-division display information.

### BACKGROUND

1. Field

The present disclosure broadly relates to a head mounted display (HMD), a digital device, and a method of controlling them, and more specifically to a HMD, a digital device, and a method of controlling them for providing a display environment to be shared by a plurality of users.

2. Description of Related Art

A head mounted display (HMD) refers to a variety of digital devices which a user wears like a glass and through which multimedia contents are provided to the user. According to weigh reduction and miniaturization of the digital devices, various wearable computers are being developed, and the above-described HMD is widely being used. Beyond a role of a simple display apparatus, the HMD may provide the use with various conveniences and experiments as combined with augmented reality technologies and N-screen technologies.

The user wearing the HMD may perform interaction with the HMD in various situations. In this instance, in order for the HMD to provide a better context-aware service to the user, more convenient user interfaces are necessary.

### SUMMARY

Exemplary embodiments have objectives to provide a display environment to be shared by a plurality of users wearing HMD.

Illustrative, non-limiting embodiments may overcome the above disadvantages and other disadvantages not described above. The inventive concept is not necessarily required to overcome any of the disadvantages described above, and the illustrative, non-limiting embodiments may not overcome any of the problems described above. The appended claims should be consulted to ascertain the true scope of the invention.

In order to resolve the above-described problem, a method of controlling a head mounted display (HMD according to an exemplary embodiment may comprise connecting to a digital device; obtaining time-division display information of the connected digital device; and opening or closing an optical shutter based on the time-division display information. Also, the time-division display information may include display time information of a first display content and a second display content of the digital device which are alternately displayed.

Also, a method of controlling a method of controlling a display of a digital device, according to an exemplary embodiment, may comprise obtaining a first display content and a second display content; connecting to at least one HMD; generating time-division display information based on connecting information of the at least one HMD; and alternately displaying the first display content and the second display content based on the time-division display information. Also, the time-division display information may include display time information of the first display content and the second display content which are alternately displayed.

According to an exemplary embodiment, a plurality of display contents can be provided to a plurality of users at the same time in a single digital device.

In this case, according to an exemplary embodiment, interference problems between the multiple display contents can be resolved, and each user can see only a specific display content selected among the multiple display contents.

Also, according to another exemplary embodiment, only the user wearing HMD can recognize the corresponding display content so that a secure display environment can be obtained.

### BRIEF DESCRIPTION OF DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a block diagram illustrating a HMD and a digital device according to an exemplary embodiment;

FIG. 2 is a flow chart illustrating a method of controlling a digital device according to an exemplary embodiment;

FIG. 3 is a flow chart illustrating a method of controlling a HMD according to an exemplary embodiment;

FIG. 4 and FIG. 5 illustrate a method of controlling a HMD and a digital device according to an exemplary embodiment; and

FIG. 6 and FIG. 7 illustrate a method of controlling HMDs 100a and 100b and a digital device according to another exemplary embodiment.

### DETAILED DESCRIPTION OF EXEMPLARY EMBODIMENTS

All terms including descriptive or technical terms which are used herein should be construed as having meanings that are obvious to one of ordinary skill in the art. However, the terms may have different meanings according to an intention of one of ordinary skill art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

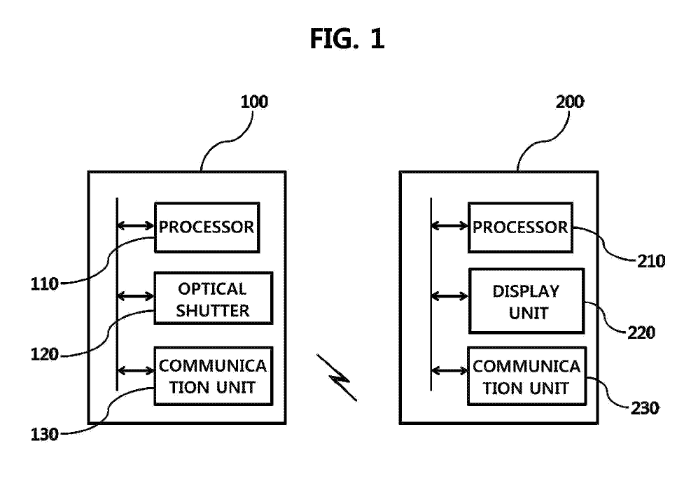

FIG. 1 is a block diagram illustrating a HMD and a digital device according to an exemplary embodiment.

In the present disclosure, the HMD 100 may include a variety of devices which a user can wear and which can provide display means, such as Eye Mounted Display (EMD), eyeglasses, eye piece, eye wear, Head Worn Display (HWD), etc. However, exemplary embodiments according to the present disclosure are not restricted thereto. Also, configuration and operations of the HMD according to exemplary embodiments may identically be applied to usual shutter glasses. Meanwhile, the digital device 200 may include various devices which have a display unit, and can output content through the display unit. Thus, the digital device may be one of a TV, a computer, a laptop computer, a cellular phone, a portable device, a table-top display, a digital signage, a wall display, an Automatic Teller Machine (ATM), an electronic display, an electronic billboard, etc.

First, the HMD 100 may comprise a processor 110, an optical shutter 120, and a communication unit 130.

The optical shutter 120 may adjust a light transmission under control of the processor 110. The optical shutter 120 may preferably be equipped in a glass of the HMD 100, and adjust the amount of lights penetrating through the glass. When the optical shutter 120 is opened, the light can be transmitted through the glass of the HMD 100. On the contrary, when the optical shutter is closed, the light can be blocked out in the glass.

Then, the communication unit 130 may transmit and receive data by performing communications with an external device or a server via various protocols. In an exemplary embodiment, the communication unit 130 may perform communications with the digital device 200 by using various communication means. In this case, a near field communication (NFC), a ZigBee, an infra-red communication, a Bluetooth, a WiFi, or a cellular network may be used as the communication means. However, the exemplary embodiment is not restricted thereto. The communications between the HMD 100 and the digital device 200 may be performed by using one or combination of the above-described communication means.

Then, the processor 110 may control various operations of the HMD 100. The processor 110 may execute an operating system (OS), various applications or multimedia content. According to an exemplary embodiment, the processor 110 may control open/close of the optical shutter 120 based on time-division display information obtained from the digital device 200. In addition, the processor 110 may control the above-described respective units of the HMD 100, and control data transmission/reception among the respective units.

Also, the digital device 200 may comprise a processor 210, a display unit 220, and a communication unit 230.

First, the display unit 220 may output images in a display screen. The display unit 220 may output a content played by the processor 210, or output images based on a control command of the processor 210.

Then, the communication 230 may have a configuration identical or similar to that of the communication 130 in the HMD 100. That is, the communication unit 230 may perform communications with the HMD 100 by using the above-described various types of communication means.

Then, the processor 210 may control various operations of the digital device 200. The processor 210 may execute an operating system (OS), various applications or multimedia content. According to an exemplary embodiment, the processor 210 may generate time-division display information on the basis of information on the HMD 100 connected to the digital device 200. The time-division display information may include time point information of a first display content and a second display content which the digital device 200 outputs. The processor 210 may alternately output the first display content and the second display content to the display unit 220 based on the generated time-division display information. In addition, the processor 210 may control the above-described respective units of the digital device 200, and control data transmission/reception among the respective units.

In FIG. 1, a block diagram according to an exemplary embodiment, the elements of the HMD 100 and the digital device 200 are illustrated as separated logically. Therefore, the above-described elements of the HMD 100 and the digital device 200 may be implemented within a single chip or as multiple chips according to designer's selection.

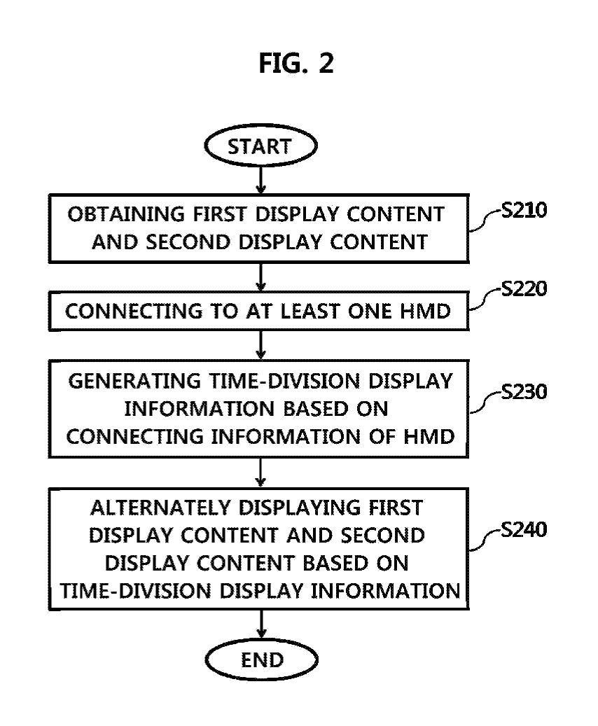

FIG. 2 is a flow chart illustrating a method of controlling a digital device according to an exemplary embodiment. Respective steps of FIG. 2 may be performed by the digital device 200. That is, the processor 210 of the digital device 200, illustrated in FIG. 1, may control the respective steps of FIG. 2.

First, the digital device 200 may obtain the first display content and the second display content (S210). The first display content and the second display content may be output to the display unit of the digital device. According to an exemplary embodiment, the digital device may receive the first display content and the second display content from a server or a cloud through the communication unit. According to another exemplary embodiment, the digital device may obtain the first display content and the second display content from a storage unit equipped in the digital device. According to yet another exemplary embodiment, the digital device may obtain the first display content from the server or the storage unit, and generate the second display content based on connecting information of the HMD 100. In this case, the second display content may be a noise content for securely displaying the first display content.

Then, the digital device may connect to at least one HMD (S220). For connecting the digital device to the at least one HMD, a separate pairing or communication access procedure may be performed. Such the pairing or access procedure may be performed according to a user input on the HMD or the digital device. After the connecting is completed, the digital device can obtain connecting information of the HMD. The connecting information of the HMD may include device information of the corresponding HMD, information on a start time of the connecting, etc.

Then, the digital device may generate the time-division display information based on the connecting information of the HMD (S230). In an exemplary embodiment, the time-division display information may include display time point information of the first display content and the second display content. According to an exemplary embodiment, the digital device may alternately display the first display content and the second display content. In this instance, the time-division display information include information on display time points, intervals, and sequence of the respective display contents which are alternately displayed. Also, the display intervals of the first display content and the second display content may be configured to be identical to or different from each other.

According to an exemplary embodiment, the digital device may be connected to a single HMD. In this case, the digital device may provide the first display content to be provided to the user wearing the HMD together with the second display content which is the noise content for the first display content.

According to another exemplary embodiment, the digital device may be connected to a plurality of HMDs. In this case, the digital device may provide a plurality of display contents based on the number of connected HMDs. That is, when the digital device is connected to two HMDs, the digital device may provide two display contents or less at the same time. Also, when the digital device is connected to three HMDs, the digital device may provide three display contents or less at the same time. The digital device can display the plurality of display contents at different times. For this, the digital device may generate time-division display information for determining display times of respective display contents. In an exemplary embodiment, the time-division display information may be determined based on device information of the respective HMDs connected to the digital device. For example, the digital device may generate time-division display information representing a display time of the first display content corresponding to the first HMD and a display time of the second display content corresponding to the second HMD.

Then, the digital device may alternately display the first display content and the second display content based on the time-division display information (S240). The digital device displays only the first display content and does not display the second display content at the display time of the first display content. On the contrary, the digital device displays only the second display content and does not display the first display content at the display time of the second display content. According to exemplary embodiment, when the digital device displays three display contents or more at the same time, it may alternately display respective display contents by displaying only one display content at a specific time.

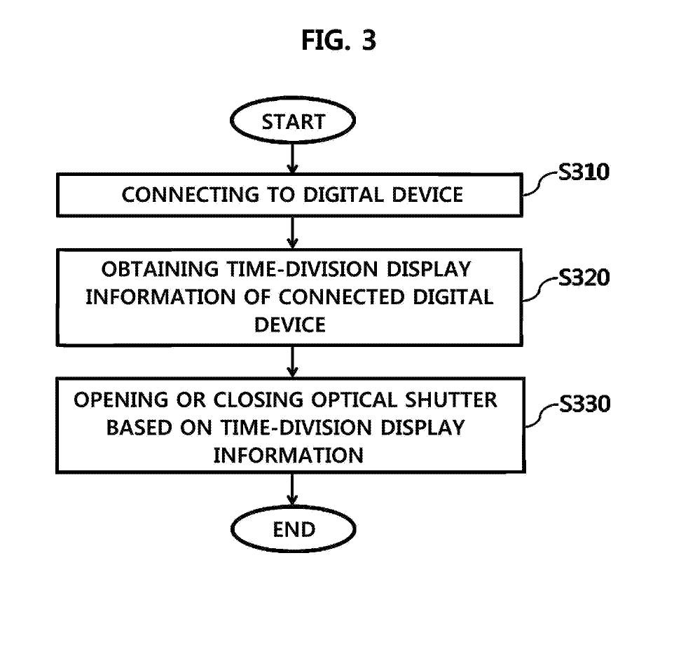

FIG. 3 is a flow chart illustrating a method of controlling a HMD according to an exemplary embodiment. Respective steps of FIG. 3, which will be explained hereinafter, may be performed by the HMD 100. That is, the processor 110 of the HMD 100 illustrated in FIG. 1 may control respective steps of FIG. 3.

First, the HMD may connect to the digital device (S310). The method of connecting the HMD to the digital device may be identical to that of the step S220 of FIG. 2.

Then, the HMD may obtain time-division display information of the connected digital device (S320). As described above, the time-division display information include display time information of the first display content and the second display content of the digital device which are alternately displayed. The detail on the time-division display information may be identical to that of the step S230 of FIG. 2.

Then, the HMD may open or close the optical shutter based on the obtained time-division display information (S330). According to an exemplary embodiment, the HMD may open the optical shutter at the display time of the first display content, and close the optical shutter at the display time of the second display content. In this instance, the second display content may be a noise content outputted by the digital device. According to another exemplary embodiment, the HMD may open the optical shutter at the display time of one of the first display content and the second display content, and close the optical shutter at the display time of the other display content. In this instance, it may be determined based on device information of the corresponding HMD whether the optical shutter is opened at the display time of the first display content or at the display time of the second display content.

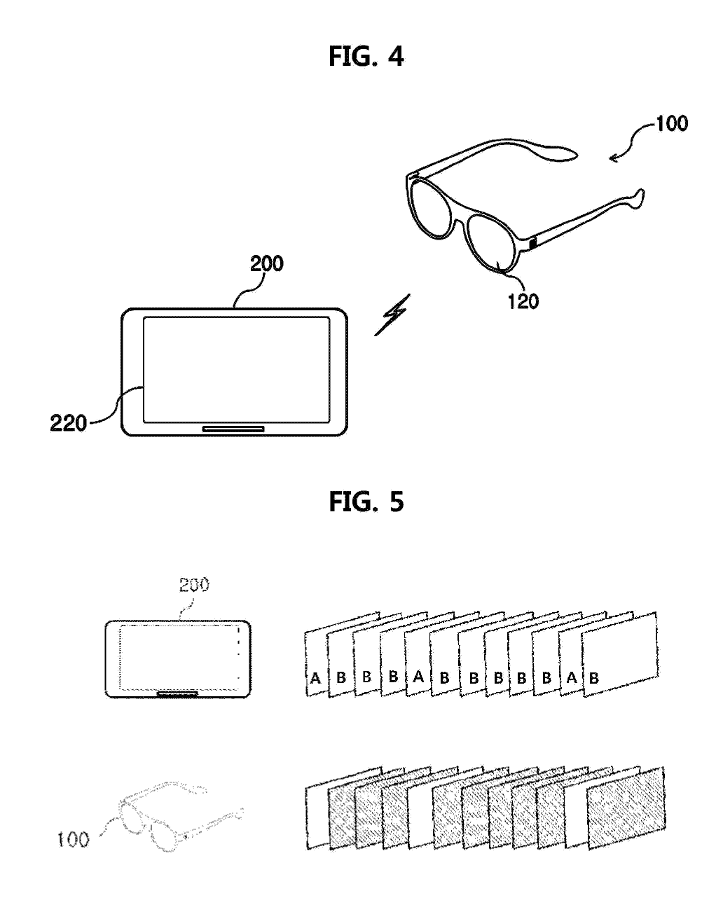

FIG. 4 and FIG. 5 illustrate a method of controlling a HMD and a digital device according to an exemplary embodiment. In the exemplary embodiment of FIG. 4 and FIG. 5, the digital device 200 is connected to the single HMD 100.

When the digital device 200 connects to the HMD 100, the digital device 200 may generate time-division display information based on connecting information of the HMD 100. The digital device 100 200 may alternately display the first display content and the second display content through the display unit 220 based on the time-division display information. In FIG. 5, frames denoted as ‘A’ constitute the first display content, and frames denoted as ‘B’ constitute the second display content. According to an exemplary embodiment, ‘B’ frames may constitute a noise content for securely displaying ‘A’ frames. In this instance, display frequency of ‘A’ frames may be configured to be higher than that of ‘A’ frames.

Meanwhile, white frames of the HMD 100 may indicate open-states of the optical shutter 120 in the IIMD 100, and grey frames may indicate close-states of the optical shutter 120 in the HMD 100. As illustrated, the HMD 100 may open the optical shutter at the display times of ‘A’ frames and close the optical shutter at the display times of ‘B’ frames by using the time-division display information obtained from the digital device 200. Accordingly, the user wearing the HMD 100 can see only ‘A’ frames displayed by the digital device 200. If a user who does not wear the HMD 100 sees the display unit 220 of the digital device 200, the user sees mixture of ‘A’ frames and ‘A’ frames so that the user cannot correctly identify the display content of ‘A’ frames. Especially, when the display frequency of B frames is far higher than that of ‘A’ frames, recognition rate of ‘A’ frames may become lower due to afterimages of ‘B’ frames. However, the user wearing the HMD 100 can see only ‘A’ frames selectively among ‘A’ frames and ‘B’ frames so that the user can correctly identify the display content constituted by ‘A’ frames.

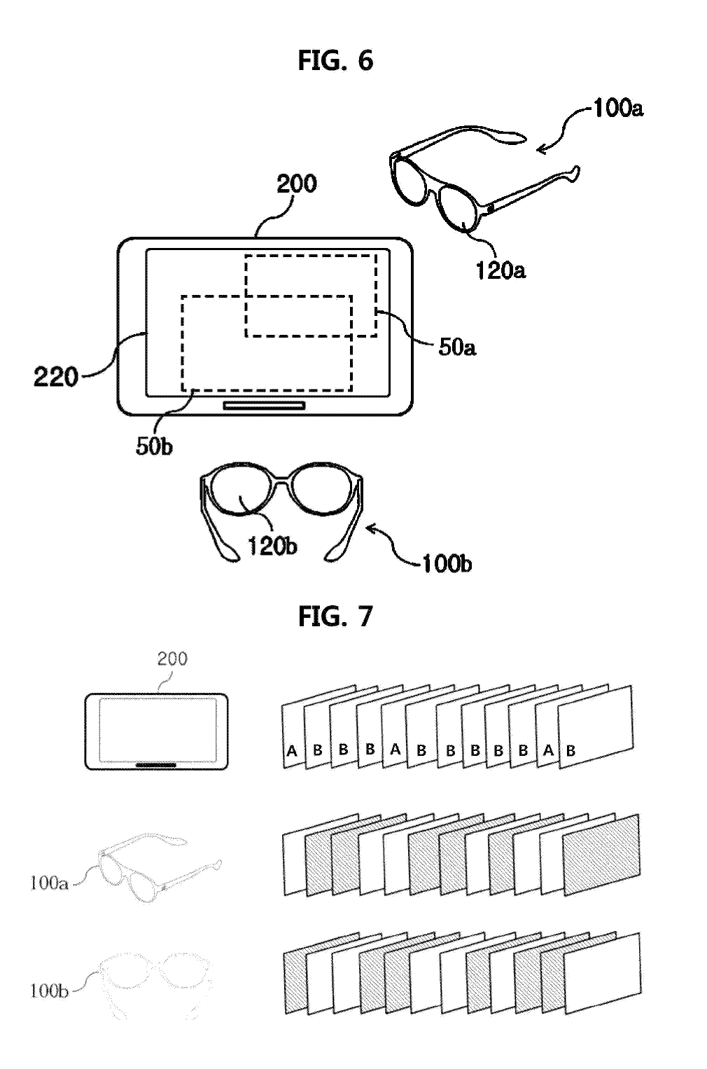

FIG. 6 and FIG. 7 illustrate a method of controlling HMDs 100a and 100b and a digital device according to another exemplary embodiment. In the exemplary embodiment of FIG. 6 and FIG. 7, the digital device 200 is connected to two HMDs 100a and 100b.

When the digital device 200 is connected to the HMDs 100a and 100b, the digital device 200 may generate time-division display information based on connecting information of the HMDs 100a and 100b. The digital device 200 may alternately display the first display content 50a and the second display content 50b through the display unit 220 based on the time-division display information. The first display content 50a is provided to the user wearing the HMD 100a, and the second display content 50b is provided to the user wearing the HMD 100b. In FIG. 7, ‘A’ frames may constitute the first display content 50a, and ‘B’ frames may constitute the second display content 50b. In an exemplary embodiment, a display interval of the first display content 50a and a display interval of the second display content 50b may be configured to be identical to or different from each other.

Meanwhile, in FIG. 7, white frames of the HMDs 100a and 100b may indicate open-states of the optical shutters 120a and 120b of the HMDs 100a and 100b, and grey frames may indicate close-states of the optical shutters 120a and 120b. As illustrated, the HMD 100a may open the optical shutter 120a at the display times of ‘A’ frames and close the optical shutter 120a at the display times of ‘B’ frames by using the time-division display information obtained from the digital device 200. Also, the HMD 100b may open the optical shutter 120b at the display times of ‘B’ frames and close the optical shutter 120a at the display times of ‘A’ frames by using the time-division display information obtained from the digital device 200. Accordingly, the user wearing the HMD 100a can see only ‘A’ frames displayed by the digital device 200, and the user wearing the HMD 100b can see only ‘B’ frames displayed by the digital device 200.

Referring to FIG. 6, there may be regions in which the display content 50a and the display content 50b provided by the digital device 200 are overlapped. However, since the user wearing the HMD 100a and the user wearing the HMD 100b can respectively see only the first display content 50a or the second display content 50b, interferences between multiple display contents can be removed.

On the other hand, although a method in which the digital device connects two HMDs 100a and 100b and controls the display unit is illustrated in FIG. 6 and FIG. 7, the exemplary embodiments according to the present disclosure are not restricted thereto. That is, the digital device 200 may be simultaneously connected to three or more HMDs, and control the display unit.

While exemplary embodiments have been described above in detail, it should be understood that various modification and changes may be made without departing from the spirit and scope of the inventive concept as defined in the appended claims and their equivalents.

1. A method of controlling a head mounted display (HMD), the method comprising:
connecting to a digital device;
obtaining time-division display information of the connected digital device; and
opening or closing an optical shutter based on the time-division display information,
wherein the time-division display information include display time information of a first display content and a second display content of the digital device which are alternately displayed

2. The method according to claim 1, wherein, in the opening or closing the optical shutter part, the optical shutter is open at a display time point of the first display content, and closed at a display time point of the second display content.

3. The method according to claim 2, wherein the digital device is connected to a single HMD, and the second display content is a noise content.

4. The method according to claim 1, wherein the digital device is connected to a plurality of HMDs, and the time-division display information is determined based a number of the plurality of HMDs connected to the digital device.

5. The method according to claim 1, wherein the digital device is connected to a plurality of HMDs, and the time-division display information is determined based device information of respective HMDs of the connected plurality of HMDs.

6. The method according to claim 1, wherein the time-division display information includes display intervals of the first display content and the second display content.

7. The method according to claim 6, wherein a display interval of the first display content is different from a display interval of the second display content.

8. A head mounted display (HMD) comprising:
a processor controlling operations of the HMD;
a communication unit for transmitting/receiving data according to a command of the processor; and
an optical shutter for adjusting a light transmission according to a command of the processor,
wherein the processor is configured to connect to a digital device, obtain time-division display information of the connected digital device, and open or close the optical shutter based on the time-division display information,
wherein the time-division display information include display time information of a first display content and a second display content of the digital device which are alternately displayed.
